(19) United States
(12) Patent Application Publication
(10) Pub. No.: US 2007/0128461 A1
(43) Pub. Date: Jun. 7, 2007

(54) Polarization film and fabrication thereof

(75) Inventor: Cheng Hsin Tsai, Taoyuan City (TW)

Correspondence Address: QUINTERO LAW OFFICE, PC, 2210 MAIN STREET, SUITE 200, SANTA MONICA, CA, 90405, US

(73) Assignee: DAXON TECHNOLOGY INC., TAOYUAN (TW)

(21) Appl. No.: 11/454,286

(22) Filed: Jun. 15, 2006

(30) Foreign Application Priority Data
Dec. 2, 2005 (TW) TW94142541

(51) Int. Cl. B32B 27/20; B32B 29/00; B29D 7/01; B29C 55/02

(52) U.S. Cl. 428/532; 428/500; 264/1.34; 264/78; 264/289.6

(57) ABSTRACT

A method for forming a polarization film is disclosed. A polyvinyl alcohol, PVA film is provided. The PVA film is swollen, and then dyed and stretched in a solution, wherein the solution comprises iodine, potassium iodide, EDTA and calcium ions. The dyed PVA film is re-stretched, and the dyed PVA film is reacted with crosslink agent.

### BACKGROUND OF THE INVENTION

1. Field of the Invention

The invention relates to a polarization film and fabrications thereof, and more particularly to a polarization film doped with iodine and fabrications thereof.

2. Description of the Related Art

Due to wider applications of liquid crystal displays, such as monitors, cell phones, notebooks or flat screen television, the demands for polarization film is increasing. Polarization films, however, are required to be improved to achieve better polarization and endurance characteristics to withstand environmental conditions.

The method for forming a polarization film comprises adsorbing iodine or dichroic dye to a non-aligned polyvinyl alcohol, PVA film, and stretching the PVA film. In addition, the method for forming a polarization film can also comprise first stretching a PVA film, and then adsorbing iodine or dichroic dye to the polyvinyl alcohol, PVA film. Adsorbing iodine or dichroic dye to a non-aligned PVA film and then stretching the PVA film is a most popular method due to simple process and good optical characteristics. Due to the evaporating characteristic of iodine, polarization film, however, easily deteriorates in wet or hot environments. Kokai discloses doping cobalt ions to a polarization film dyed with iodine in Japanese patent No 56-48601 to eliminate easy deterioration of polarization films. In addition, Kokai also discloses doping nickel ions to a polarization film dyed with iodine in Japanese patent No 62-18030. U.S. Pat. No. 5,071,234 discloses doping zirconium and manganese ions to a polarization film dyed with iodine. U.S. Pat. No. 5,093,041 disclosed a light-polarizing material based on ethylenediamine polyacetic acid derivatives, which is used in a crystal dissolved in a suitable solvent.

### BRIEF SUMMARY OF THE INVENTION

A detailed description is given in the following embodiments with reference to the accompanying drawings. These and other problems are generally solved or circumvented, and technical advantages are generally achieved, by preferred illustrative embodiments of the present invention, which provide a polarization film.

The invention provides a polarization film. A plurality of polyiodides comprising a micro structure with longer polyiodides and shorter polyiodides are in a PVA film, wherein the number of longer polyiodides is greater than that of shorter polyiodides.

The invention further provides a polarization plate. A plurality of polyiodides comprising a micro structure with longer polyiodides and shorter polyiodides are in a PVA film, wherein the number of longer polyiodides is greater than that of shorter polyiodides. Saponificated TAC (triacetyl cellulose) films are bonded on both sides of the PVA film by hydrogel, providing a polarization plate.

### BRIEF DESCRIPTION OF THE DRAWINGS

The present invention can be more fully understood by reading the subsequent detailed description and examples with references made to the accompanying drawings, wherein:

FIG. 1 shows a cross section of a polarization plate of an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims. Embodiments of the invention, which provides a polarization plate and/or a polarization film, will be described in greater detail by referring to the drawings that accompany the invention. It is noted that in the accompanying drawings, like and/or corresponding elements are referred to by like reference numerals.

EDTA, a strong chelating reagent toward metal ions, was used as a polyiodide carrier along with calcium ion in an embodiment of the invention. Here we adopt the idea of “polyiodide carrier” and try to apply on the polarizer manufacturing process.

Non-aligned polyvinyl alcohol, PVA film is swollen in water. Next, the swollen PVA film is put in an iodine solution containing [EDTA-calcium ions] to dye. In this step, the PVA film is stretched to adsorb iodine and to be aligned. Preferably, the duration of the step is more than 3 minutes to achieve better dying efficiency.

The iodine solution containing [EDTA-calcium ions] can be prepared by the following steps. First, EDTA powders and calcium salts are dissolved in a potassium iodide solution, and the resulted mixture is stirred till achieving a clear solution. Next, solid iodine is added into the solution and the solution is stirred. The iodine solution containing EDTA and calcium salts can also be prepared by the following steps. First, EDTA and calcium salts are added into water to form a first solution. Next, the first solution is mixed with an iodine solution containing molecular iodine to form a second solution wherein the iodine solution further contains potassium iodide.

In an embodiment of the invention, the chelated EDTA can be provided by free form EDTA, EDTA monovalent metal salt, EDTA metal salt hydrate or EDTA calcium salt. The EDTA monovalent metal salt can be a EDTA-4Na salt. Preferably, the concentration of the EDTA in the iodide solution is about 0.1 wt %˜5 wt %. More preferably, the concentration of the EDTA in the iodide solution is about 0.5 wt %˜3 wt %.

The calcium ions can be provided by EDTA calcium salts, calcium-containing EDTA sodium salts or typical inorganic calcium salts. Preferably, the calcium salts are soluble inorganic calcium salts, such as CaCl₂, Ca(NO₃)₂ or Cal₂. More preferably, the calcium salts are Ca(NO₃)₂. In a preferred embodiment of the invention, the mole concentration of the calcium ions is larger than the mole concentration of the EDTA, thus, the solution can have uniform [EDTA-Ca²⁺] concentration. The ratio of calcium ions to EDTA is not limited. The calcium ions can also be provided by EDTA calcium salts. Inorganic calcium salts are directly dissolved in an iodide solution, and further additions can also be provided in the same way. The analysis error of complex titration of EDTA and calcium ion can be less than 1%.

In conventional technology, the metal ions serve as dopants of a polarization film. Different from conventional technology, the [EDTA-calcium ions] complex in the embodiment of the present invention serve as a polyiodide carrier. Covalence radius of each ion is provided for comparison. Covalence radius of calcium is 1.16 \acute{Å}. Covalence radius of nickel is 1.15 \acute{Å}. Covalence radius of manganese is 1.17 \acute{Å}. Covalence radius of zirconium is 1.17 \acute{Å}. Typically, the ion radius of a metal ion is similar to the covalence radius thereof. Therefore, the covalence radiuses can be used as references to compare ion radiuses of the metal ions. Since EDTA has strong chelating affinity toward divalent metal ions and calcium ions have larger radius, calcium ions are not easily permeated into the polarization film. When iodine solution is mixed with [EDTA-calcium ions] complex, the polyiodides in the solution can be permeated into the aligned helix structure of PVA film. In addition, since the iodine solution and the [EDTA-calcium ions] complex can increase the opportunity of forming polyiodides according to the structure of the complex, polyiodides with longer micro structure, such as structures serially connecting three or five iodine ions, are achieved. The polyiodides with longer micro structure permeated in the polarization film has better immovability and polarization characteristics. Thus, polyiodides with longer micro structure is greater in number than those with shorter micro structure in the PVA film comprising a plurality of iodide ions, wherein polyiodides with longer micro structure are structures serially connecting three or five iodine ions, and polyiodides with shorter micro structure are single iodide ions or single iodine molecules.

Since the [EDTA-calcium ions] can serially connect iodine to form polyiodides with longer micro structure which are not easily separated out after permeating into the polarization film, better optical characteristics and endurance of heat and moisture are achieved. Consequently, reliability of the polarization film is increased. Additionally, the mechanism of [EDTA-calcium ions] reacting with iodine and iodide ions of the embodiment is distinct from that of conventional technology. In the embodiment of the invention, metal ions doped in the polarization film can be reduced by finely adjusted quantities of EDTA and calcium ions to eliminate instability of the polarization film.

Next, a re-stretching step is performed to further stretch the dyed PVA film and react the PVA film with a crosslink reagent. After the abovementioned steps, the ratio of the stretched PVA film to the original unstretched PVA film is 4-7. Preferably, the crosslink agent is boric acid or borax (sodium tetraborate). Thereafter, the stretched PVA film is dried to achieve a polarization film.

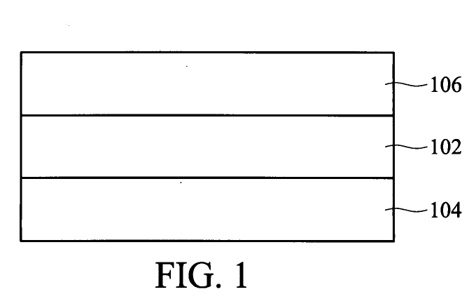

FIG. 1 shows a cross section of a polarization plate of an embodiment of the invention. Referring to FIG. 1, the fabricated polarization film (PVA film) 102 is bonded to saponificated TAC films 104 and 106 by hydrogel to form a polarization plate with three-layer structure, providing a polarization plate of one embodiment in the present invention.

A protective film is further attached to the polarization plate on one of the TAC films, and a pressure sensitive adhesive is coated on the other thereof. Next, a release film is attached to the pressure sensitive adhesive to form a standard polarization plate structure in market. Additionally, the polarization plate can be further bonded to various optical films through adhesives, such as a retardation film, a reflective plate or a bright enhancement film to have different optical characteristics.

A practical example and a plurality of comparative examples are provided in the following. Optical characteristics of examples are measured by a spectrometer, wherein Y represents transmittance and V represents polarization efficiency of the polarization film. In the following examples, the steps are utilized in the same process conditions in addition to dying contents. Concentrations of the metal ions of the solutions of the examples are fined tune to a similar mole concentration by complex titration. The results are shown in the table 1 below.

### PRACTICAL EXAMPLE 1

First, a PVA film is swollen, and then stretched and dyed in a first solution, wherein the first solution comprises an iodine, EDTA with a concentration of 1.0 wt % and calcium with a concentration of 0.5 wt %, and the process temperature is 25° C.˜35° C. EDTA and calcium ions are provided from EDTA sodium salts and Ca(NO₃)₂. Next, the dyed film is re-stretched to a re-stretching ratio of about 4.5. The re-stretch step is utilized in a 5.5 wt % boric acid and 6 wt % potassium iodide, and the process temperature is about 50° C. Thereafter, the polarization film is dried. Saponificated triacetyl cellulose, TAC is bonded through hydrogel to both sides of the polarization film for protection. Consequently, a polarization plate comprising three layers is finalized. Finally, an endurance test at a temperature of 75° C. and a humidity of 90% is utilized for a duration of 8 hours.

### COMPARATIVE EXAMPLE 1

First, a PVA film is swollen, and then stretched and dyed in a first solution, wherein the first solution comprises an iodine solution and cobalt ions with a concentration of 0.74 wt %, and the process temperature is 25° C.˜35° C. Cobalt ions are provided from hexahydrate cobalt chloride. Next, the dyed film is re-stretched to a re-stretching ratio of about 4.5. The re-stretch step is utilized in 5.5 wt % boric acid and 6 wt % potassium iodide, and the process temperature is about 50° C. Thereafter, the polarization film is dried. Saponificated triacetyl cellulose, TAC is bonded through hydrogel to both sides of the polarization film for protection. Consequently, a polarization plate comprising three layer is finalized. Finally, an endurance test at a temperature of 75° C. and a humidity of 90% is utilized for. a duration of 8 hours.

### COMPARATIVE EXAMPLE 2

First, a PVA film is swollen, and then stretched and dyed in a first solution, wherein the first solution comprises an iodine solution and manganese ions with a concentration of 0.68wt %, and the process temperature is 25° C.˜35° C. Manganese ions are provided from tetra-hydrate manganese chloride. Next, the dyed film is re-stretched to a re-stretching ratio of about 4.5. The re-stretch step is utilized in 5.5 wt % boric acid and 6 wt % potassium iodide, and the process temperature is about 50° C. Thereafter, the polarization film is dried. Saponificated triacetyl cellulose, TAC is bonded through hydrogel to both sides of the polarization film for protection. Consequently, a polarization plate comprising three layers is finalized. Finally, an endurance test of a temperature of 75° C. and a humidity of 90% is utilized for a duration of 8 hours.

### COMPARATIVE EXAMPLE 3

First, a PVA film is swollen, and then stretched and dyed in a iodide solution. Next, the dyed film is re-stretched to a re-stretching ratio of about 4.5. The re-stretch step is utilized in 5.5 wt % boric acid and 6 wt % potassium iodide, and the process temperature is about 50° C. Thereafter, the polarization film is dried. Saponificated triacetyl cellulose, TAC is bonded through hydrogel to both sides of the polarization film for protection. Consequently, a polarization plate comprising three layers is finalized. Finally, an endurance test at a temperature of 75° C. and a humidity of 90% is utilized for a duration of 8 hours.

TABLE 1

| | | | After | |
|---|---|---|---|---|
| Testing | Initial state | | endurance test | |
| film | Transmittance(Y %) | Polarization(V %) | ΔY | ΔV |
| Practical | 42.5 | 99.978 | +0.2 | −0.1 |
| example 1 | | | | |
| Comparative | 43.8 | 99.84 | +0.7 | −1.3 |
| example 1 | | | | |
| Comparative | 44 | 99.8 | +0.9 | −1.5 |
| example 2 | | | | |
| Comparative | 45.2 | 99.25 | +3.3 | −5.2 |
| example 3 | | | | |

Table 1 shows that the polarization film or the polarization plate fabricated by a method of an embodiment of the invention presents better polarization characteristics. Table 1 also shows that after the endurance test, the polarization film of an embodiment of the invention presents lower variation of transmittance and polarization (ΔY, ΔV), having better hot and wet endurance.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for forming a polarization film, comprising:
providing a polyvinyl alcohol, PVA film;
swelling the PVA film;
dying and stretching the PVA film in a solution , wherein the solution comprises iodine, potassium iodide, EDTA and calcium ions; and
re-stretching the dyed PVA film and reacting the dyed PVA film with a crosslink agent simultaneously.

2. The method as claimed in claim 1, wherein the EDTA is provided by EDTA free form, EDTA monovalent metal salt, EDTA metal salt hydrate or EDTA calcium salt.

3. The method as claimed in claim 1, wherein concentration of the EDTA is 0.1 wt %˜5 wt %.

4. The method as claimed in claim 1, wherein the calcium ions are provided by EDTA calcium salts, calcium containing EDTA sodium salts or typical inorganic calcium salts.

5. The method as claimed in claim 1, wherein the inorganic calcium salts are CaCl₂, Ca(NO₃)₂, Cal₂ or other soluble inorganic calcium salts.

6. The method as claimed in claim 1, wherein the ratio of the re-stretched PVA film to the original not stretched PVA film is 4˜7.

7. The method as claimed in claim 1, wherein the crosslink agent is boric acid or Borax (Sodium Tetraborate).

8. A polarization film, comprising:
a polyvinyl alcohol, PVA film; and
a plurality polyiodides comprising a micro structure with longer polyiodides and shorter polyiodides in the PVA film, wherein a number of longer polyiodides is greater than the number of shorter polyiodides

9. The polarization film as claimed in claim 8, wherein the longer polyiodides comprising three or five serially connected iodine or iodine ions.

10. The polarization film as claimed in claim 8, wherein the shorter polyiodides are single iodine molecules or iodine ions.

11. A polarization plate, comprising a substrate and a polarization film on the substrate, wherein the polarization film is formed by the method as claimed in claim 1.

12. A polarization plate, comprising:
a polyvinyl alcohol, PVA film; and
a plurality polyiodides comprising a micro structure with longer polyiodides and shorter polyiodides in the PVA film, wherein a number of longer polyiodides is greater than the number of shorter polyiodides; and
saponificated triacetyl cellulose, TAC films bonded on both sides of the PVA film by hydrogel.

13. The polarization plate as claimed in claim 12, wherein the longer polyiodides comprise five or three serially connected iodine or iodine ions.

14. The polarization plate as claimed in claim 13, wherein the shorter polyiodides are single iodine molecules or iodine ions.
